(19) United States
(12) Patent Application Publication
(10) Pub. No.: US 2009/0031665 A1
(43) Pub. Date: Feb. 5, 2009

(54) Window and Door Profile with an Inherent Metal Reinforcement and Two PVC Profiles

(76) Inventor: Bekir Esen, Kayseri (TR)

Correspondence Address: AKERMAN SENTERFITT, P.O. BOX 3188, WEST PALM BEACH, FL, 33402-3188, US

(21) Appl. No.: 12/095,426

(22) PCT Filed: Nov. 29, 2006
(86) PCT No.: PCT/TR2006/000063

§ 371 Date: Sep. 5, 2008

(30) Foreign Application Priority Data
Nov. 30, 2005 (TR) 2005-04775

(51) Int. Cl. E06B 3/22

(52) U.S. Cl. 52/656.2

(57) ABSTRACT

This invention relates to pvc window and door profiles with an inherent metal reinforcement which provides for convenient assembly in the process of producing the final products with an inherent reinforcement plate, a convenient production and a saving of 70% in the use of screws with drill ends during production of the products, and eliminate the human error risks, wherein the metal reinforcement plate is made of aluminium and is fixed to two pvs semi-profiles.

This invention relates to the pvc window and door profiles with inherent metal reinforcement, the purpose of which is to provide convenient assembly in the process of producing the final products with inherent reinforcement plate, to eliminate the human error risks, and to provide a saving of 70% in the use of screws with drill ends during production of the products and a convenient production thereof.

This product is not currently in use. This product is improved as an alternative for some problems that occur during the production of the products with reinforcement plates which are currently in use.

### GROUNDS OF INVENTION

### 1—To Ensure a Convenient Assembly During Production;

The profiles with reinforcement plates currently available on market, are assembled from above downwards. This means that an aluminum reinforcement plate which is designed to be located between two plastic semi-profiles, and a pvc that is connected to this sheet are made by mounting the tabs provided on the aluminum reinforcement plate to the channels provided on the pvc semi-profiles by 6 meters from above downwards.

However, with the product according to the present invention, there are channels with spaces between each other in the aluminum reinforcement plate (3), which are brought in between two pvc profiles (1) by placing one at the top of the other without being passed over from above, and to which the tabs (2) provided on the pvc profile are compressed with a tab sealing machine, whereby both a time saving is ensured and the strength is enhanced.

### 2—To Eliminate the Human Error Factor in Production;

As it is known, the galvanized reinforcement plates must be placed in the profiles used for pvc door and window applications. Because the reinforcement plate is the backbone structure of pvc profile.

However, although it is known in this way, it was not possible for a consumer to Liz know whether a reinforcement plate is included in the pvc profile which is already mounted in its place if a malicious producer does not place the reinforcement plate in the pvc profile. Since it is unusual for such a pvc profile to function as it should, the risks it may bring are obvious.

A product with inherent reinforcement plate is created based on this fact, thereby it is ensured that a pvc profile (1) having an aluminum reinforcement plate (3) that is compressed thereon at the time of initial production, is offered to the final consumer, and the factor of human error is eliminated.

3—A 70% Reduction in the Screws with Drill Ends Used in the Production of pvc Profiles;

It is inevitable for the pvc profiles currently available in the market that the screws with drill ends are screwed in with specific spaces therebetween to join the galvanized reinforcement plate to the pvc profiles.

But, in this product according to the present invention, thanks to the process of interlocking and compressing the reinforcement plate (3) and pvc profile (1), a profile is produced on a reinforcement plate without using any screws. Thereby, not only the screws are saved, but also a middle mullion having two screw holes and another middle mullion having such screw holes across its length are joined with a metal-to-metal connection by two steel screws of 4.8+60, thereby 60 screws on average are used for the product with inherent reinforcement plate according to present invention, as compared to 160 screws on average used in the currently available frame with two openings and 6 chambers covering 18 meters, given that such pvc profiles need a zamak alloy joint and 6 or 8 screws per each zamak joint, and the profile provides a saving of 4 or 6 screws at each joint.

The profile with the characterstics above ensures a 70% saving from screws and also a saving in the time spent for screwing.

### 4—Advantages in Transportation and Storage Due to its Inherent Reinforcement Plate

The pvc door and window profiles currently available on market require more space for both transportation and storage since their reinforcement plates are separate products. However, this new profiles with reinforcement plates thereon, ensure a saving in transportation and storage.

### CHARACTERISTICS OF INVENTION

The semi-profiles made of pvc (1) according to present invention are provided with two tabs of 4 mm in various shapes to be compressed to the reinforcement plate (3) made of aluminum. According to the present invention, there are also 4 tabs (2) on the reinforcement plate (3) made of aluminum to compress the tabs of pvc semi-profiles, 2 of which are located at the right side and 2 of which are located at the left side thereof.

Each frame and middle mullion profile has 6 chambers and each shutter profile has 7 chambers for heat and sound insulation.

Each frame profile with inherent reinforcement plate has 1 grey sealing tab and each shutter and middle mullion profile has 2 grey sealing tabs.

The aluminum reinforcement plate (3) which is located in the middle of the middle mullion profile with inherent reinforcement plate, is provided at the exact inside center thereof, with screwing channels that extend along the profile and to which two steel screws of 4.8×60 size can be mounted, and the parts of this aluminum reinforcement plate in between the profiles, which are seen inside, can be painted with the color of pvc profile, all contribute to the harmony between the parts.

### DESCRIPTION OF FIGURES

FIG. 1: A frame profile of 70

FIG. 2: A middle mullion profile of 70

FIG. 3: A window shutter profile of 70

FIG. 4: A door shutter profile of 70

FIG. 5: A door shutter profile of 70 opening outward

FIG. 6: A final form before assembly

FIG. 7: A final form after assembly

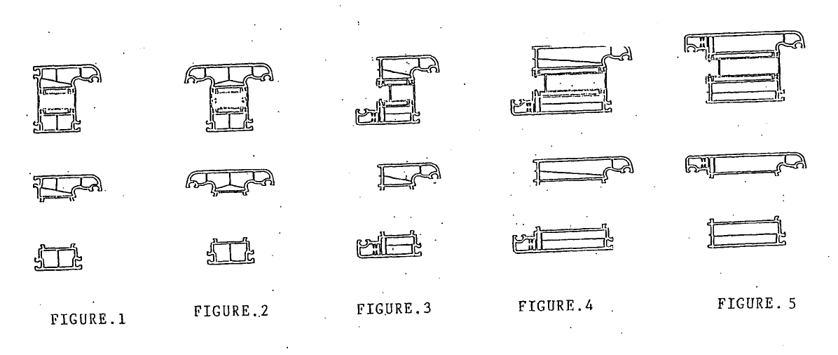

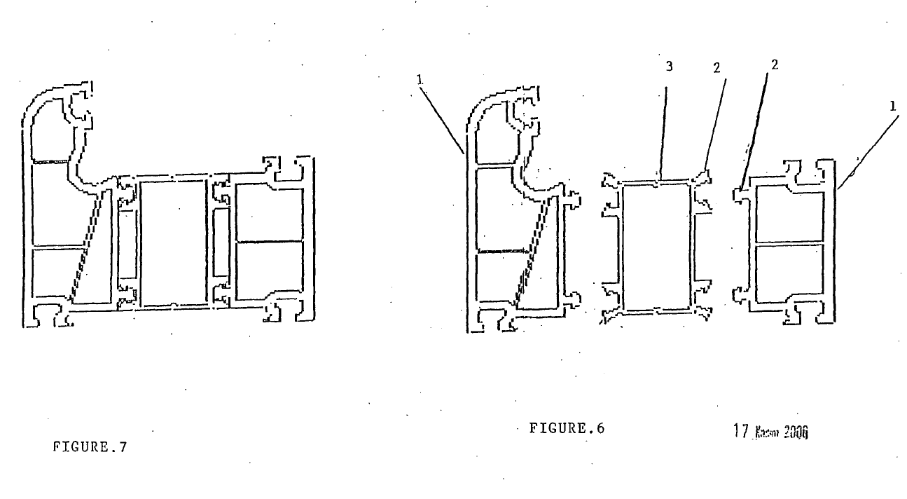

The elements referred with numerals in the figures;
(1) pvc profile
(2) tab
(3) aluminum reinforcement plate

1. PVC window and door profiles with inherent metal reinforcements comprising:
two PVC semi-profiles;
an aluminum reinforcement plate located between the two PVC semi-profiles; and
two tabs of various shapes provided on the PVC semi-profiles, to be compressed to the aluminum reinforcement plate.

2. The PVC window and door profiles with inherent metal reinforcements according to claim 1, further comprising four tabs on the aluminum reinforcement plate to compress the tabs of the PVC semi-profiles, two of which are located at the right side and two of which are located at the left side thereof.

3. The PVC window and door profiles with inherent metal reinforcements according to claim 1, wherein each frame profile and middle mullion profile has six chambers inside and each shutter profile has seven chambers for heat and sound insulation.

4. The PVC window and door profiles with inherent metal reinforcements according to claim 1, wherein each frame profile with inherent reinforcement plate has one sealing tab and each shutter and each middle mullion profile has two sealing tabs.

5. The PVC window and door profiles with inherent metal reinforcements according to claim 1, wherein the aluminum reinforcement plate which is located in the middle of a middle mullion profile with inherent reinforcement plate, is provided at the exact inside center thereof, with screwing channels that extend along the profile and to which two screws can be mounted, and the parts of this aluminum reinforcement plate in between the profiles, which are seen inside, can be painted with the color of PVC profiles.

6. The PVC window and door profiles according to claim 1, wherein the two tabs on the PVC semi-profiles are 4 mm in size.

7. The PVC window and door profiles according to claim 4, wherein the sealing tabs are grey.

8. The PVC window and door profiles according to claim 5, wherein the screws are steel screws having a size of 4.8×60.
